(19) United States
(12) Patent Application Publication
(10) Pub. No.: US 2025/0074396 A1
(43) Pub. Date: Mar. 6, 2025

(54) VEHICLE DRIVING CONTROL METHOD AND VEHICLE CONTROL DEVICE

(71) Applicants: HYUNDAI MOTOR COMPANY, SEOUL (KR); KIA CORPORATION, SEOUL (KR)

(72) Inventors: Sung Jae Oh, Hwaseong-si (KR); Jun Yong Lee, Seongnam-si (KR); Jin Kyeom Cho, Suwon-si (KR); Sung Ik Jo, Hwaseong-si (KR); Ji Hun Choi, Goyang-si (KR); Seung Eun Yu, Bucheon-si (KR); Sung Ho Kim, Hwaseong-si (KR)

(21) Appl. No.: 18/411,796

(22) Filed: Jan. 12, 2024

(30) Foreign Application Priority Data
Sep. 4, 2023 (KR) 10-2023-0117077

(51) Int. Cl. B60W 30/02; B60W 30/14

(52) U.S. Cl. CPC B60W 30/025; B60W 30/143; B60W 2540/22; B60W 2720/106

(57) ABSTRACT

A vehicle control device and a vehicle driving control method include determining whether a motion sickness prevention mode is entered, based on road condition information and user-configured information about whether to activate the motion sickness prevention mode, during driving of a vehicle, and controlling, when the motion sickness prevention mode is entered, the vehicle based on a torque profile generated to reduce a passenger's feeling of acceleration or deceleration depending on whether the vehicle accelerates or decelerates in a high-speed driving situation where the vehicle's speed exceeds a predetermined first reference speed.

### CROSS REFERENCE TO RELATED APPLICATIONS

This application is based on and claims priority under 35 U.S.C. § 119 to Korean Patent Application No. 10-2023-0117077, filed on Sep. 4, 2023, in the Korean Intellectual Property Office, the disclosure of which is herein incorporated by reference in its entirety.

### BACKGROUND

### Technical Field

The present disclosure relates to a vehicle control device and a vehicle driving control method for controlling the driving of a vehicle to reduce motion sickness of a passenger riding in the vehicle.

### Background

With the recent advancement of various sensors and recognition systems, driver assistance systems and autonomous driving systems that consider driver convenience and safety can control the driving of a vehicle without a driver's intervention.

However, as the amount of time spent in a vehicle increases, passengers in the vehicle may experience motion sickness when the passengers are in the vehicle for a long time or are in a traffic jam area with repeated stops and starts. Motion sickness may occur due to various causes, and in particular, discomfort due to perceptual disparity between the field of view and longitudinal acceleration may be the most significant cause of motion sickness.

As described above, in a traffic jam area, the frequent occurrence of acceleration or deceleration of the vehicle causes a sudden change in longitudinal acceleration, thereby causing motion sickness of the passengers. However, in the past, attempts were made to prevent motion sickness in passengers by detecting the motion sickness and only controlling a vehicle in the lateral direction or controlling a seat.

Therefore, in order to reduce motion sickness of passengers, it is necessary to develop a method for preventing frequent abrupt changes in longitudinal acceleration depending on the driving situation of the vehicle or addressing discomfort due to perceptual disparity between the field of view and longitudinal acceleration.

The foregoing described as the background art is intended merely to aid in the understanding of the background of the present disclosure, and is not intended to mean that the present disclosure falls within the purview of the related art already known to those skilled in the art.

### SUMMARY

The present disclosure has been made in order to solve the above-mentioned problems in the prior art and an aspect of the present disclosure is to provide a vehicle control device and a vehicle driving control method for reducing a passenger's feeling of acceleration or deceleration when a vehicle accelerates or decelerates in a vehicle driving situation, in particular, in a high-speed driving situation.

The technical subjects pursued in the present disclosure may not be limited to the above-mentioned technical subjects, and other technical subjects which are not mentioned may be clearly understood, through the following descriptions, by those skilled in the art to which the present disclosure pertains.

In order to achieve the above aspect of the present disclosure, a vehicle driving control method may include determining, by an execution determination unit, whether a motion sickness prevention mode is entered, based on road condition information and user-configured information about whether to activate the motion sickness prevention mode, during driving of a vehicle, and controlling, by a controller, when the motion sickness prevention mode is entered, the vehicle based on a torque profile generated to reduce a passenger's feeling of acceleration or deceleration depending on whether the vehicle accelerates or decelerates in a high-speed driving situation where the vehicle's speed exceeds a predetermined first reference speed.

For example, the controlling may include controlling the vehicle to decelerate based on a deceleration torque profile generated to reduce a passenger's feeling of deceleration in case that the vehicle is decelerating in the high-speed driving situation, and controlling the vehicle to accelerate based on an acceleration torque profile generated to reduce the passenger's feeling of acceleration in case that the vehicle is accelerating in the high-speed driving situation.

For example, the deceleration torque profile and the acceleration torque profile may each generated with a delayed initial torque variation compared to a preconfigured default torque profile.

For example, the controlling may include generating the deceleration torque profile when a brake-pedal position sensor receives an input in the high-speed driving situation when the motion sickness prevention mode is entered, and controlling the vehicle to decelerate based on the generated deceleration torque profile.

For example, the generating may include generating the deceleration torque profile when a deceleration input torque corresponding to a sensing value of the brake-pedal position sensor is less than a predetermined reference torque.

For example, the generating may include determining a deceleration torque gain value during deceleration in the high-speed driving situation, and generating the deceleration torque profile, based on the determined deceleration torque gain value.

For example, the controlling may include controlling the vehicle to decelerate based on one of multiple deceleration torque profiles that have been generated to have different degrees of deceleration torque control depending on at least one among a sensitivity of the passenger to deceleration and a driving mode of the vehicle.

For example, the controlling may include determining a deceleration demand torque based on the vehicle's speed to follow the deceleration torque profile, and controlling the vehicle to decelerate based on the deceleration demand torque until the vehicle's speed is equal to or lower than a predetermined second reference speed.

For example, the controlling may include generating the acceleration torque profile when an accelerator-pedal position sensor receives an input in the high-speed driving situation when the motion sickness prevention mode is entered, and controlling the vehicle to accelerate based on the generated acceleration torque profile.

For example, the generating may include determining an acceleration torque gain value during acceleration in the high-speed driving situation, and generating the acceleration torque profile based on the determined acceleration torque gain value.

For example, the controlling may include controlling the vehicle to accelerate based on one of multiple acceleration torque profiles that have been generated to have different degrees of acceleration torque control depending on at least one among a sensitivity of the passenger to acceleration and a driving mode of the vehicle.

For example, the controlling may include determining an acceleration demand torque based on the vehicle's speed to follow the acceleration torque profile, and controlling the vehicle to accelerate based on the acceleration demand torque until the vehicle's speed is equal to or higher than a predetermined third reference speed.

Furthermore, in order to achieve the above aspect of the present disclosure, a vehicle control device may include: an execution determination unit configured to determine whether a motion sickness prevention mode is entered, based on road condition information and user-configured information about whether to activate the motion sickness prevention mode, during driving of a vehicle, and a controller configured to control, when the motion sickness prevention mode is entered, the vehicle based on a torque profile generated to reduce a passenger's feeling of acceleration or deceleration depending on whether the vehicle accelerates or decelerates in a high-speed driving situation where the vehicle's speed exceeds a predetermined first reference speed.

For example, the controller may be further configured to control the vehicle to decelerate based on a deceleration torque profile generated to reduce a passenger's feeling of deceleration when the vehicle is decelerating in the high-speed driving situation, and control the vehicle to accelerate based on an acceleration torque profile generated to reduce the passenger's feeling of acceleration when the vehicle is accelerating in the high-speed driving situation.

For example, the controller may be further configured to determine a deceleration input torque corresponding to a sensing value of a brake-pedal position sensor when the brake-pedal position sensor receives an input in the high-speed driving situation when the motion sickness prevention mode is entered, generate the deceleration torque profile when the deceleration input torque is less than a predetermined reference torque, and control the vehicle to decelerate based on the generated deceleration torque profile.

For example, the controller may be further configured to control the vehicle to decelerate based on one of multiple deceleration torque profiles that have been generated to have different degrees of deceleration torque control depending on at least one among a sensitivity of the passenger to deceleration and a driving mode of the vehicle.

For example, the controller may be further configured to determine a deceleration demand torque based on the vehicle's speed to follow the deceleration torque profile, and control the vehicle to decelerate based on the deceleration demand torque until the vehicle's speed is equal to or lower than a predetermined second reference speed.

For example, the controller may be further configured to determine an acceleration torque gain value when the vehicle is accelerating in the high-speed driving situation, and generate the acceleration torque profile, based on the determined acceleration torque gain value.

For example, the controller may be further configured to control the vehicle to accelerate based on one of multiple acceleration torque profiles that have been generated to have different degrees of acceleration torque control depending on at least one among a sensitivity of the passenger to acceleration and a driving mode of the vehicle.

For example, the controller may be further configured to determine an acceleration demand torque based on the vehicle's speed to follow the acceleration torque profile, and control the vehicle to accelerate based on the acceleration demand torque until the vehicle's speed is equal to or higher than a predetermined third reference speed.

As described above, the vehicle driving control method and the vehicle control device, according to the present disclosure, may control deceleration or acceleration of a vehicle based on a torque profile generated with a delayed initial torque variation compared to an existing torque profile when the vehicle decelerates or accelerates in a high-speed driving situation, thereby reducing a driver's and a passenger's perception of deceleration or acceleration.

In addition, by reducing the driver's and the passenger's perception of deceleration or acceleration, it is possible to reduce the driver's and the passenger's discomfort due to a feeling of deceleration or acceleration and prevent motion sickness.

Advantageous effects obtainable from the present disclosure may not be limited to the above-mentioned effects, and other effects which are not mentioned may be clearly understood, through the following descriptions, by those skilled in the art to which the present disclosure pertains.

### BRIEF DESCRIPTION OF THE FIGURES

The above and other aspects, features, and advantages of the present disclosure will be more apparent from the following detailed description taken in conjunction with the accompanying drawings, in which:

FIG. 1 is a block diagram illustrating the configuration of a vehicle control device according to an embodiment of the present disclosure;

FIG. 2 is a graph illustrating a change in vehicle speed depending on the operation of a vehicle control device according to an embodiment of the present disclosure;

FIG. 3 is a graph illustrating a torque profile according to an embodiment of the present disclosure;

FIG. 4 illustrates the effect of operation of a vehicle control device according to an embodiment of the present disclosure; and

FIG. 5 is a flowchart illustrating a vehicle driving control method according to an embodiment of the present disclosure.

### DETAILED DESCRIPTION

In describing embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Hereinafter, embodiments disclosed in the present specification will be described in detail with reference to the accompanying drawings, and the same or similar elements are given the same and similar reference numerals, so duplicate descriptions thereof will be omitted.

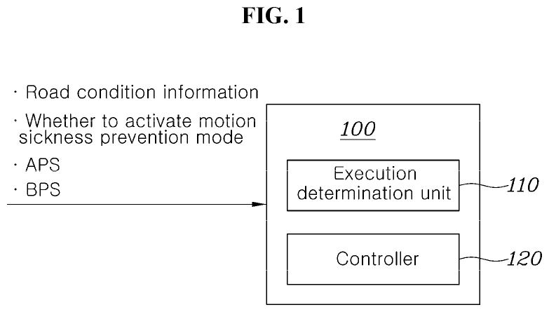

A vehicle control device according to an embodiment of the present disclosure will be described with reference to FIG. 1.

FIG. 1 is a block diagram illustrating the configuration of a vehicle control device according to an embodiment of the present disclosure.

Referring to FIG. 1, a vehicle control device 100 according to an embodiment of the present disclosure may include an execution determination unit 110 and a controller 120. FIG. 1 primarily shows elements related to an embodiment of the present disclosure, and in the actual implementation of the vehicle control device, the vehicle control device may include fewer or more elements than those shown in FIG. 1.

The execution determination unit 110 may collect road condition information and user-configured information about whether to activate a motion sickness prevention mode, during driving of a vehicle. The execution determination unit 110 may determine, based on the collected user-configured information, whether the motion sickness prevention mode is entered. The user-configured information may be configured through input from a driver and a passenger during driving of the vehicle, and may refer to information preconfigured in the initial stage. However, this is illustrative and the present disclosure is not necessarily limited thereto. The execution determination unit 110 may determine whether a motion sickness prevention mode is entered and transmit the determination result to the controller 120.

When the execution determination unit 110 determines that the motion sickness prevention mode is entered, the controller 120 may perform control based on the driving situation of the vehicle. According to an embodiment of the present disclosure, the controller 120 is configured to control acceleration or deceleration of the vehicle in a high-speed driving situation where the vehicle's speed is equal to or higher than a predetermined first reference speed. Specifically, the controller 120 may control the vehicle based on a torque profile generated to reduce a passenger's feeling of acceleration or deceleration depending on whether the vehicle is accelerating or decelerating in a high-speed driving situation. For example, the high-speed driving situation may refer to a situation in which the vehicle is traveling at a speed of 60 km/h or more, but the present disclosure is not necessarily limited to the above-described numeral value.

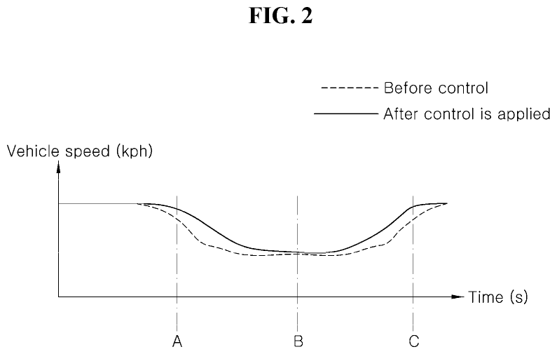

The aspect to be achieved by the operation of the vehicle control device 100 according to an embodiment of the present disclosure, in particular, the operation of the controller 120, will be described with reference to FIG. 2.

FIG. 2 is a graph illustrating a change in vehicle speed depending on the operation of a vehicle control device according to an embodiment of the present disclosure.

FIG. 2 illustrates a graph of a change in a vehicle's speed over time when the vehicle accelerates or decelerates in a high-speed driving situation. The interval between time point A and time point B may indicate a situation where the vehicle is decelerating, and the interval between time point B and time point C may indicate a situation where the vehicle is accelerating. In the previous case (dashed graph) before the operation of the vehicle control device 100 according to an embodiment of the present disclosure, i.e., before control is applied, it can be observed that when the vehicle decelerates in the interval between time point A and time point B, the vehicle's speed decreases rapidly at the beginning of entering the interval. Furthermore, in the previous case, it can be observed that the vehicle's speed increases rapidly when the vehicle accelerates in the interval between time point B and time point C. Therefore, as the vehicle's speed changes rapidly, a driver or a passenger may strongly experience a feeling of acceleration or deceleration, and thus experience motion sickness.

The vehicle control device 100 of the present disclosure is configured to control the vehicle to accelerate or decelerate so that the vehicle's speed does not change rapidly, but changes gradually compared to the previous case, as indicated by a solid line graph illustrated in FIG. 2. Therefore, the feeling of acceleration or deceleration felt by the driver and the passenger may be lower than in the previous case, and thus the driver or the passenger may be prevented from experiencing motion sickness.

Returning again to FIG. 1, hereinafter, the controller 120 will be described in detail.

The controller 120 may determine whether the vehicle is decelerating or accelerating in a high-speed driving situation. The controller 120 may control the vehicle to decelerate based on a deceleration torque profile generated to reduce a passenger's feeling of deceleration when the vehicle decelerates in the high-speed driving situation, and may control the vehicle to accelerate based on an acceleration torque profile generated to reduce a passenger's feeling of acceleration when the vehicle accelerates in the high-speed driving situation, particularly when the vehicle reaccelerates after decelerating to a predetermined speed.

The controller 120 may receive information about whether there is an input from a brake-pedal position sensor (BPS) in the high-speed driving situation of the vehicle, and may determine that the vehicle decelerates when the brake-pedal position sensor receives an input. When the brake-pedal position sensor receives an input, the controller 120 may generate a deceleration torque profile that can reduce the passenger's feeling of deceleration. In particular, the controller 120 according to an embodiment of the present disclosure may determine a deceleration input torque corresponding to a sensing value of the brake-pedal position sensor, and may generate a deceleration torque profile when the deceleration input torque is less than a predetermined reference torque.

Furthermore, the controller 120 may receive information about whether there is an input from an accelerator-pedal position sensor (APS) in a high-speed driving situation of the vehicle, and may determine that the vehicle decelerates when the accelerator-pedal sensor receives an input. When the accelerator-pedal position sensor receives an input, the controller 120 may generate an acceleration torque profile that can reduce the passenger's feeling of acceleration.

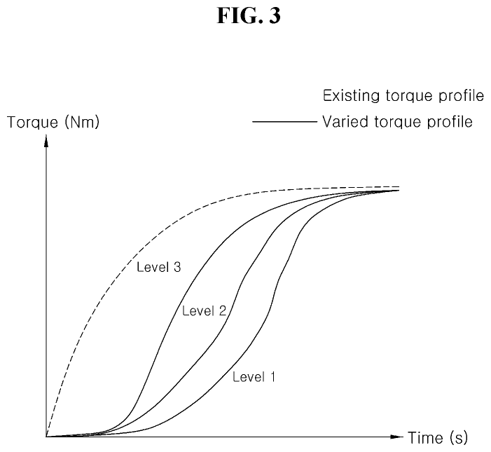

The deceleration torque profile and the acceleration torque profile may be generated with a delayed initial torque variation compared to a predetermined default torque profile. This will be described with reference to FIG. 3.

FIG. 3 illustrates a torque profile according to an embodiment of the present disclosure.

Referring to FIG. 3, the horizontal axis of a graph may indicate time, and the vertical axis may indicate torque. Accordingly, the shape shown in the graph may signify a torque profile showing a change in torque over time. Hereinafter, the acceleration torque profile will be described with reference to FIG. 3, but it should be understood that the deceleration torque profile and the acceleration torque profile according to an embodiment of the present disclosure have the same purpose, differing only in the application situation, and thus the following description is similarly applied to the deceleration torque profile.

The dashed line graph shows an existing torque profile that has been conventionally applied to vehicles. Referring to the dashed line graph, conventionally, a default torque profile has been configured to amplify a driver's feeling of acceleration. In this case, in the initial phase of acceleration, the acceleration is made rapidly, and as time passes, jerk, which is the derivative of the acceleration, may tend to decrease slowly. However, since, in the initial phase of acceleration, the acceleration is made rapidly, discomfort may occur in the acceleration perception by a driver and a passenger, and thus may cause motion sickness in the driver and the passenger.

Thus, the controller 120 according to an embodiment of the present disclosure may generate an acceleration torque profile in which jerk tends to decrease slowly by reducing the amount of change in jerk in the initial phase of acceleration such that the acceleration is made slowly, and by increasing the amount of change in jerk until the late phase of acceleration.

According to an embodiment of the present disclosure, the acceleration torque profile may be generated based on a filter function capable of calculating a force to satisfy a targeted feeling of acceleration based on a transfer function expressing the relationship between a neural signal from a person's vestibular organ (e.g., an otolith) and a force received by the person's head. In this case, the vehicle may have a target longitudinal acceleration which is configured based on the perception of the driver and the passenger and reflects the characteristics of the vehicle, and based on this, the acceleration torque profile may be generated through the filter function. However, this is illustrative, and the present disclosure is not necessarily limited thereto.

The filter function for generating the acceleration torque profile according to an embodiment of the present disclosure may be represented as shown in Equation 1 below.

$$\frac{Force}{Acceleration Feeling} = \frac{( 5 s + 1 ) \cdot ( 0. 016 s + 1 )}{( Xs + 1 )} \frac{{ω}_{lf}}{( s + {ω}_{lf} )} \qquad Equation 1$$

In Equation 1 above, s may represent the frequency, X may represent the human sensitivity, and ω_{lf} may represent the acceleration torque gain value. The controller 120, according to an embodiment of the present disclosure, may determine a passenger's sensitivity and an acceleration torque gain value to generate, through Equation 1 above, an acceleration torque profile that reduces the passenger's feeling of acceleration when the vehicle accelerates in a high-speed driving situation.

Furthermore, in Equation 1 above, the controller 120 may vary X depending on the human sensitivity, and may vary ω_{lf}, which is the acceleration torque gain value, depending on the driving mode of the vehicle. For example, the controller 120 may collect information about a passenger's sensitivity and the driving mode (e.g., an eco-driving mode and a sport driving mode) of a vehicle, and may generate multiple acceleration torque profiles by varying the corresponding values (X, ω_{lf}) in the above filter function, based on the collected information. In other words, the controller 120 according to an embodiment of the present disclosure may generate multiple acceleration torque profiles to have different degrees of acceleration torque control depending on at least one of a passenger's sensitivity to acceleration and the driving mode of a vehicle.

When the vehicle decelerates in a high-speed driving situation, the above-described acceleration torque gain value may correspond to a deceleration torque gain value, and the controller 120 may generate, based on the filter function, a deceleration torque profile in consideration of the deceleration torque gain value. Furthermore, the controller 120 may generate multiple deceleration torque profiles to have different degrees of deceleration torque control, depending on at least one of the passenger's sensitivity to deceleration and the driving mode of the vehicle.

Thus, the acceleration torque profile according to an embodiment of the present disclosure may be generated to have a solid-line graph shape, which may be a varied torque profile compared to an existing one. Furthermore, the multiple acceleration torque profiles may be generated at multiple levels (Level 1 to Level 3) based on different degrees of acceleration torque control.

In addition, the foregoing may be similarly applied to the deceleration torque profile, and the deceleration torque profile may also be generated to have a shape similar to the graph shape of the acceleration torque profile shown in FIG. 3. However, this is exemplary, and the present disclosure is not necessarily limited thereto.

Referring again to FIG. 1, the controller 120 may control the vehicle to accelerate based on the acceleration torque profile generated as described above. When multiple acceleration torque profiles are generated, the controller 120 may output information about the multiple generated acceleration torque profiles so that the passenger can configure one of the multiple acceleration torque profiles. The driver may configure one of the multiple acceleration torque profiles by manipulating a predetermined control device, such as a steering wheel or a paddle shift disposed on a steering column. Accordingly, the controller 120 may control the vehicle to accelerate based on the one configured acceleration torque profile among the multiple acceleration torque profiles. This may be applied in the same manner even when multiple deceleration torque profiles are generated.

When controlling deceleration of the vehicle, the controller 120 may control the vehicle to decelerate while following a generated deceleration torque profile. Specifically, the controller 120 may determine a deceleration demand torque based on the vehicle's speed so as to follow the deceleration torque profile, and may input the determined deceleration demand torque to control the vehicle to decelerate. In this case, the controller 120 may control the vehicle to decelerate based on the determined deceleration demand torque until the vehicle's speed is equal to or lower than a predetermined second reference speed (e.g., 30 km/h). In other words, the controller 120 may discontinue the control when the vehicle's speed is equal to or lower than the predetermined second reference speed. By doing so, it is possible to make the passenger experience less deceleration feeling when the vehicle decelerates in a high-speed driving situation, thereby reducing the passenger's discomfort due to a change in longitudinal acceleration when the vehicle is decelerating, and preventing motion sickness.

When controlling acceleration of the vehicle, the controller 120 may control the vehicle to accelerate while following the generated acceleration torque profile. Specifically, the controller 120 may determine an acceleration demand torque based on the vehicle's speed so as to follow the acceleration torque profile, and may input the determined acceleration demand torque to control the vehicle to accelerate. In this case, the controller 120 may control the vehicle to accelerate, based on the acceleration demand torque determined based on the vehicle speed so as to follow the acceleration torque profile, until the vehicle speed is equal to or higher than a predetermined third reference speed. In other words, the controller 120 may discontinue the control when the vehicle's speed is equal to or higher than the predetermined third reference speed (e.g., 80 km/h). By doing so, it is possible to make the passenger experience less acceleration feeling when the vehicle accelerates in a high-speed driving situation, thereby reducing the passenger's discomfort due to a change in longitudinal acceleration when the vehicle is decelerating, and preventing motion sickness.

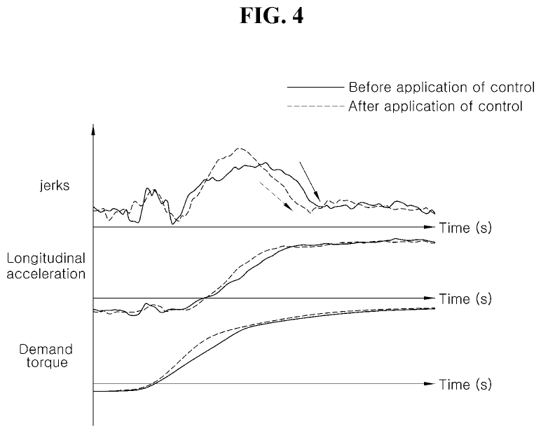

Hereinafter, the effect of operation of the controller 120 according to an embodiment of the present disclosure will be described with reference to FIG. 4.

FIG. 4 illustrates the effect of operation of a vehicle control device according to an embodiment of the present disclosure.

Referring to FIG. 4, the horizontal axis may represent time, and the vertical axis may represent demand torque, longitudinal acceleration, and jerk, respectively, and in particular, longitudinal acceleration according to demand torque and jerk according to the demand torque.

Solid line graphs each represent physical quantities before application of control through the vehicle control device 100 according to an embodiment of the present disclosure. Dashed line graphs each represent physical quantities after application of control through the vehicle control device 100 according to an embodiment of the present disclosure. It is assumed that FIG. 4 shows physical quantities measured during acceleration of a vehicle.

Referring to FIG. 4, when examining the graph of jerk based on demanded torque before the application of control, it can be observed that there is an interval in which jerk suddenly increases or decreases. This may eventually make the vehicle's passenger feel discomfort due to the perception of acceleration, and the passenger may suffer from motion sickness due to the discomfort. On the other hand, when a control operation is applied through the vehicle control device 100 according to an embodiment of the present disclosure, demanded torque that tracks an acceleration torque profile may be applied. With the application of demanded torque, when examining the graph of jerk based on the demanded torque, it can be observed that there are intervals where jerk suddenly increases or decreases but the degree of increase or decrease is reduced compared with before the control is applied. Thus, application of the control of the vehicle control device 100 according to embodiments of the present disclosure may reduce the degree of increase or decrease in jerk compared with before the control is applied, thereby making the passenger feel less discomfort due to the perception of acceleration, and thus preventing the passenger from experiencing motion sickness due to the discomfort.

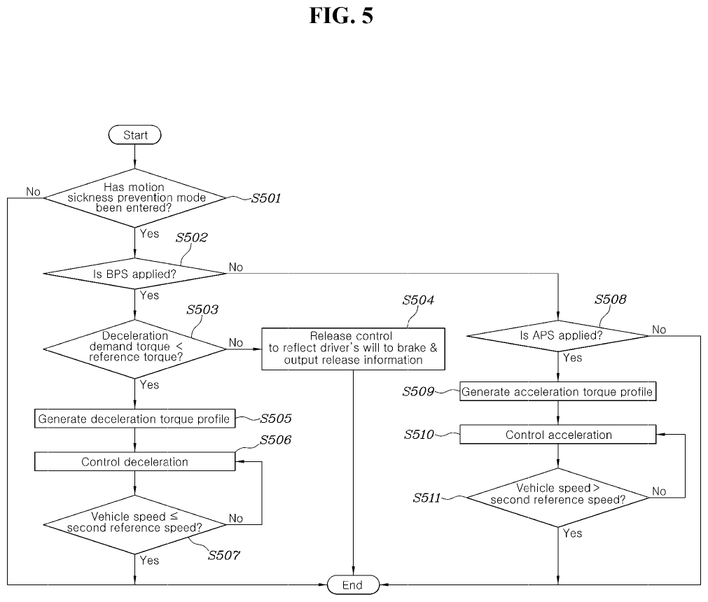

Hereinafter, a vehicle driving control method according to an embodiment of the present disclosure will be described with reference to FIG. 5, based on the above-described configuration of the vehicle control device 100 in FIG. 1.

FIG. 5 is a flowchart illustrating a vehicle driving control method according to an embodiment of the present disclosure.

Referring to FIG. 5, the execution determination unit 110 may determine whether a motion sickness prevention mode is entered, based on road condition information and user-configured information about whether to activate the motion sickness prevention mode, during driving of a vehicle (S501).

When the execution determination unit 110 determines that the motion sickness prevention mode is entered (Yes in S501), the controller 120 may determine whether the vehicle accelerates or decelerates in a high-speed driving situation.

First, the controller 120 may determine whether a brake-pedal position sensor receives an input (S502), and when the brake-pedal position sensor has received an input (Yes in S502), the controller 120 may determine that the vehicle decelerates in the high-speed driving situation. Then, the controller 120 may determine a deceleration input torque corresponding to a sensing value of the brake-pedal position sensor and compare the determined deceleration input torque with a predetermined reference torque (S503).

When the determined deceleration input torque is greater than or equal to the predetermined reference torque (No in S503), the controller 120 may determine that a driver is willing to brake, may release control so that deceleration control is not performed, and may output information about the release of the control so that the driver and a passenger are aware of the release of the control (S504).

When the determined deceleration input torque is less than the predetermined reference torque (Yes in S503), the controller 120 may generate a deceleration torque profile that reduces a feeling of deceleration experienced by the driver and the passenger (S505). Since this has been described above with reference to FIG. 3, a detailed description thereof will be omitted. When the deceleration torque profile is generated, the controller 120 may control the vehicle to decelerate while following the generated deceleration torque profile (S506). The controller 120 may determine whether the vehicle's speed is equal to or lower than a predetermined second reference speed when controlling the vehicle to decelerate (S507). When the vehicle's speed is equal to or lower than the predetermined second reference speed due to the deceleration of the vehicle (Yes in S507), the controller 120 may stop controlling the vehicle to decelerate.

In a situation where the vehicle is traveling at a high speed, the controller 120 may determine whether an accelerator-pedal position sensor receives an input (S508). When the accelerator-pedal position sensor has received an (Yes in S508), the controller 120 may determine that the vehicle is accelerating. When the accelerator-pedal position sensor has received an input (Yes in S508), the controller 120 may generate an acceleration torque profile (S509) to reduce the feeling of acceleration experienced by the driver and the passenger. Since this has been described above with reference to FIG. 3, a detailed description thereof will be omitted.

When the acceleration torque profile is generated, the controller 120 may control the vehicle to accelerate while following the generated acceleration torque profile (S510). Then, the controller 120 may determine whether the vehicle's speed is equal to or higher than a predetermined third reference speed when controlling the vehicle to accelerate (S511). When the vehicle's speed is equal to or higher than the predetermined third reference speed due to the acceleration of the vehicle (Yes in S511), the controller 120 may stop controlling the vehicle to accelerate.

As described above, the vehicle driving control method and the vehicle control device, according to the present disclosure, may control deceleration or acceleration of a vehicle based on a torque profile generated with a delayed initial torque variation compared to an existing torque profile when the vehicle decelerates or accelerates in a high-speed driving situation, thereby reducing a driver's and a passenger's perception of deceleration or acceleration.

In addition, by reducing the driver's and the passenger's perception of deceleration or acceleration, it is possible to reduce the driver's and the passenger's discomfort due to a feeling of deceleration or acceleration and prevent motion sickness.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Further, the above detailed description should not be construed in a limitative sense, but should be considered in an illustrative sense in all aspects. The scope of the present disclosure should not be determined by reasonable interpretation of the appended claims, and all changes and modifications within the equivalent scope of the present disclosure fall within the scope of the present disclosure.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

1. A vehicle driving control method comprising:
determining, by an execution determination unit, whether a motion sickness prevention mode is entered, based on road condition information and user-configured information about whether to activate the motion sickness prevention mode, during driving of a vehicle; and
controlling, by a controller, when the motion sickness prevention mode is entered, the vehicle based on a torque profile generated to reduce a passenger's feeling of acceleration or deceleration depending on whether the vehicle accelerates or decelerates in a high-speed driving situation where the vehicle's speed exceeds a predetermined first reference speed.

2. The vehicle driving control method of claim 1, wherein the controlling comprises:
controlling the vehicle to decelerate based on a deceleration torque profile generated to reduce a passenger's feeling of deceleration in case that the vehicle is decelerating in the high-speed driving situation; and
controlling the vehicle to accelerate based on an acceleration torque profile generated to reduce the passenger's feeling of acceleration in case that the vehicle is accelerating in the high-speed driving situation.

3. The vehicle driving control method of claim 2, wherein the deceleration torque profile and the acceleration torque profile are each generated with a delayed initial torque variation compared to a preconfigured default torque profile.

4. The vehicle driving control method of claim 2, wherein the controlling comprises:
generating the deceleration torque profile when a brake-pedal position sensor receives an input in the high-speed driving situation when the motion sickness prevention mode is entered; and
controlling the vehicle to decelerate based on the generated deceleration torque profile.

5. The vehicle driving control method of claim 4, wherein the generating comprises generating the deceleration torque profile when a deceleration input torque corresponding to a sensing value of the brake-pedal position sensor is less than a predetermined reference torque.

6. The vehicle driving control method of claim 4, wherein the generating comprises:
determining a deceleration torque gain value during deceleration in the high-speed driving situation; and
generating the deceleration torque profile, based on the determined deceleration torque gain value.

7. The vehicle driving control method of claim 4, wherein the controlling comprises controlling the vehicle to decelerate based on one of multiple deceleration torque profiles that have been generated to have different degrees of deceleration torque control depending on at least one among a sensitivity of the passenger to deceleration and a driving mode of the vehicle.

8. The vehicle driving control method of claim 2, wherein the controlling comprises:
determining a deceleration demand torque based on the vehicle's speed to follow the deceleration torque profile; and
controlling the vehicle to decelerate based on the deceleration demand torque until the vehicle's speed is equal to or lower than a predetermined second reference speed.

9. The vehicle driving control method of claim 2, wherein the controlling comprises:
generating the acceleration torque profile when an accelerator-pedal position sensor receives an input in the high-speed driving situation when the motion sickness prevention mode is entered; and
controlling the vehicle to accelerate based on the generated acceleration torque profile.

10. The vehicle driving control method of claim 9, wherein the generating comprises:
determining an acceleration torque gain value during acceleration in the high-speed driving situation; and
generating the acceleration torque profile based on the determined acceleration torque gain value.

11. The vehicle driving control method of claim 9, wherein the controlling comprises controlling the vehicle to accelerate based on one of multiple acceleration torque profiles that have been generated to have different degrees of acceleration torque control depending on at least one among a sensitivity of the passenger to acceleration and a driving mode of the vehicle.

12. The vehicle driving control method of claim 2, wherein the controlling comprises:
determining an acceleration demand torque based on the vehicle's speed to follow the acceleration torque profile; and
controlling the vehicle to accelerate based on the acceleration demand torque until the vehicle's speed is equal to or higher than a predetermined third reference speed.

13. A vehicle control device comprising:
an execution determination unit configured to determine whether a motion sickness prevention mode is entered, based on road condition information and user-configured information about whether to activate the motion sickness prevention mode, during driving of a vehicle; and
a controller configured to, when the motion sickness prevention mode is entered, control the vehicle based on a torque profile generated to reduce a passenger's feeling of acceleration or deceleration depending on whether the vehicle accelerates or decelerates in a high-speed driving situation where the vehicle's speed exceeds a predetermined first reference speed.

14. The vehicle control device of claim 13, wherein the controller is further configured to:
control the vehicle to decelerate based on a deceleration torque profile generated to reduce a passenger's feeling of deceleration when the vehicle is decelerating in the high-speed driving situation; and
control the vehicle to accelerate based on an acceleration torque profile generated to reduce the passenger's feeling of acceleration when the vehicle is accelerating in the high-speed driving situation.

15. The vehicle control device of claim 14, wherein the controller is further configured to:
determine a deceleration input torque corresponding to a sensing value of a brake-pedal position sensor when the brake-pedal position sensor receives an input in the high-speed driving situation when the motion sickness prevention mode is entered;
generate the deceleration torque profile when the deceleration input torque is less than a predetermined reference torque; and
control the vehicle to decelerate based on the generated deceleration torque profile.

16. The vehicle control device of claim 15, wherein the controller is further configured to control the vehicle to decelerate based on one of multiple deceleration torque profiles that have been generated to have different degrees of deceleration torque control depending on at least one among a sensitivity of the passenger to deceleration and a driving mode of the vehicle.

17. The vehicle control device of claim 14, wherein the controller is further configured to:
determine a deceleration demand torque based on the vehicle's speed to follow the deceleration torque profile; and
control the vehicle to decelerate based on the deceleration demand torque until the vehicle's speed is equal to or lower than a predetermined second reference speed.

18. The vehicle control device of claim 14, wherein the controller is further configured to:
determine an acceleration torque gain value when the vehicle is accelerating in the high-speed driving situation; and
generate the acceleration torque profile, based on the determined acceleration torque gain value.

19. The vehicle control device of claim 18, wherein the controller is further configured to control the vehicle to accelerate based on one of multiple acceleration torque profiles that have been generated to have different degrees of acceleration torque control depending on at least one among a sensitivity of the passenger to acceleration and a driving mode of the vehicle.

20. The vehicle control device of claim 14, wherein the controller is further configured to:
determine an acceleration demand torque based on the vehicle's speed to follow the acceleration torque profile; and
control the vehicle to accelerate based on the acceleration demand torque until the vehicle's speed is equal to or higher than a predetermined third reference speed.
